(19) United States
(12) Patent Application Publication
(10) Pub. No.: US 2025/0373853 A1
(43) Pub. Date: Dec. 4, 2025

(54) PROGRAMMABLE STREAMING ARCHITECTURE FOR LOW-ENERGY HUMAN-CENTRIC VISION APPLICATIONS

(71) Applicants: Georgia Tech Research Corporation, Atlanta, GA (US); Northwestern University, Evanston, IL (US)

(72) Inventors: John Mamish, Atlanta, GA (US); Josiah Hester, Atlanta, GA (US); Rawan Alharbi, Evanston, IL (US); Nabil Alshurafa, Evanston, IL (US)

(21) Appl. No.: 19/227,080

(22) Filed: Jun. 3, 2025

Related U.S. Application Data
(60) Provisional application No. 63/655,452, filed on Jun. 3, 2024.

(51) Int. Cl. H04N 19/625; G06T 5/10; H04N 19/124

(52) U.S. Cl. CPC H04N 19/625; G06T 5/10; H04N 19/124

(57) ABSTRACT

Disclosed is a programmable streaming architecture designed for low-energy, human-centric vision applications (e.g., wearable lifelogging cameras). The disclosed device address the privacy concerns, battery life, and device size issues in existing devices. The disclosed device provides a low-power architecture for wearable cameras that allows for programmable early-discard of video frames at both frame and pixel levels. Obfuscation masks are generated on-the-fly from non-visual sensor data, enabling the device to process and store only relevant portions of video streams while discarding unnecessary data, thus enhancing privacy and extending battery life.

### FEDERAL FUNDING

This invention was made with government support from the National Science Foundation under award number 1915847. The government has certain rights in the invention.

### CROSS-REFERENCE TO RELATED APPLICATIONS

This application claims priority to U.S. Prov. Pat. Appl. No. 63/655,452, filed Jun. 3,2024, which is hereby incorporated by reference.

### BACKGROUND

Human studies often rely on wearable lifelogging cameras that capture videos of individuals and their surroundings to aid in visual confirmation or recollection of daily activities like eating, drinking, and smoking. Because the images may include private or sensitive information, however, some users may opt to refrain from using such monitoring devices. Meanwhile, the short battery lifetime and large form factors of existing monitoring devices reduces their applicability for long-term capture of human activity.

Despite wearable cameras becoming smaller and more capable, there is a need for an improved device that simultaneously satisfies the four requirements for such systems: compactness, system lifetime, system performance, and privacy protection.

### SUMMARY

Disclosed is NIR-sighted (pronounced Near-sighted), an architecture for compact and low power wearable video cameras that enables programmable early-discard at a frame-level and pixel-level granularity for continuous mobile vision. Early-discard is the notion of only storing those portions of a video stream that are relevant to the application and discarding the rest before it reaches the microcontroller (MCU). With NIR-sighted, early-discard is enabled by obfuscation masks that are generated “on the fly” from sensors in a programmatic way. Masked portions are discarded as the video streams. NIR-sighted's early-discard capabilities can be used to implement on-device obfuscation, which has demonstrated utility for privacy-enhancement and can extend system lifetime by recording less and giving programmers a more fine-grained ability to control data rate and image streams via sensor signals. Furthermore, NIR-sighted allows for the use of small and low-power MCUs without sacrificing resolution or frame rate.

Also disclosed is NIR-sightedCam, a camera that implements the NIR-sighted architecture. In some embodiments, NIRsightedCam is a neck-worn, egocentric camera that uses a thermal sensor to enable pixel-level obfuscation of the video stream on-the-fly and fully on-device. Enabled by NIR-sighted's architectural innovations, NIR-sightedCam has a high frame rate, a compact form-factor, multi-day lifetime, and privacy-enhancing, programmer-definable video obfuscation. NIR-sighted is enabled by two key ideas:

Use another sensor to help with masking: Generating masks directly from high-resolution image sensor data requires significant memory and computational power, which negatively impacts system bulkiness and lifetime. Instead, NIR-sighted's obfuscation masks are generated using a different sensor than the primary image sensor, like a low-resolution IR imager or depth camera. Application-specific and program-defined masks can be crafted with this data as input. For example, an eating study using a neck-worn egocentric camera can mask out everything except for a wearer's face. A study focused on user surroundings can do the exact opposite, discarding all pixels belonging to the user's face before saving video to memory. Whatever the study goal, a definition of early-discard can be embedded in a binary, per-frame 2D mask that is programmatically generated from non-visual-spectrum cameras. That programmatic mask generation capability enables NIR-sighted to provide application-specific flexibility to obfuscate any portion of the video without having to store the obfuscated portion at any time.

Never buffer the whole uncompressed image: Compression is a necessity for storing video data (24 hours of uncompressed 15 fps 320×240 grayscale video will fill 99.5 gigabytes). Compressing in software at high framerates is computationally intractable for small microcontrollers. Commercially available MCUs with hardware JPEG codecs require the full image to be buffered in memory and don't allow any type of non-MCU transformation of the image beyond compression. Even for low-resolution imagers, this immediately puts memory requirements into the 100 s of kB, ruling out the most compact MCUs. Furthermore, buffering prevents the use of imagers with a resolution above 640×480 without using external DRAM.

In embodiments, NIR-sighted solves that issue by moving video compression to a bespoke, tunable motion JPEG (mJPEG) compressor (e.g., implemented on a 5280-LUT iCE40UP5K FPGA) called Blindspot that requires little power (e.g., 5 mW to compress 320×240 images at 20 fps) and little memory, even for high-resolution video, because it never buffers more than a portion (e.g., 16 lines) of the uncompressed source image. That enables systems to obfuscate and compress HD (720p) video streams even with very small and low-power microcontrollers having only a few kB of RAM. Crucially, unlike other commercially available hardware JPEG compressors, Blindspot takes as input the binary mask described above and applies that mask to the image in-situ as compression occurs.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a block diagram of an image capture and compression device according to exemplary embodiments.

FIG. 2 is a flowchart illustrating a process for obfuscating, compressing, and storing images according to exemplary embodiments.

FIG. 3 is a block diagram illustrating a hardware-implemented (e.g., FPGA-implemented) obfuscation-aware compressor according to exemplary embodiments.

FIG. 4 is an image of a modular implementation of the disclosed image capture and compression device according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

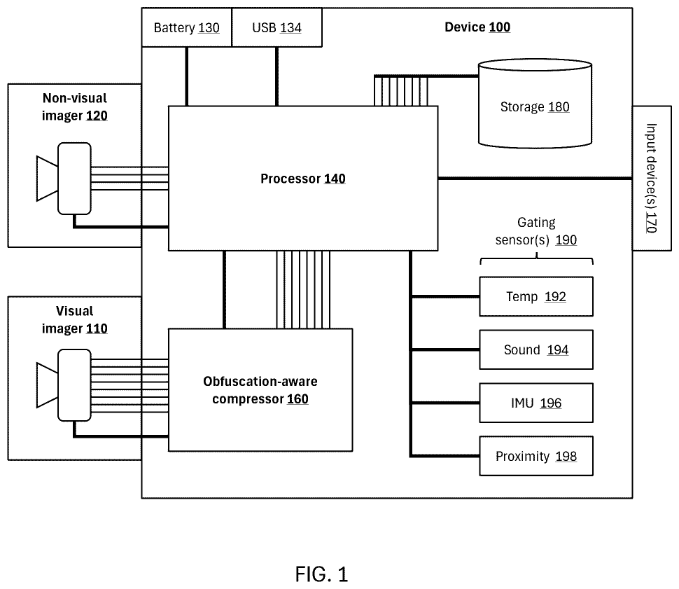

FIG. 1 is a block diagram of an image capture and compression device 100 according to exemplary embodiments.

In the embodiment of FIG. 1, the device 100 includes a visual imager 110, a power source (e.g., a battery 130), one or more ports (e.g., a universal serial bus (USB) port 134), a processor 140, one or more input devices 170 (e.g., buttons), and non-transitory computer readable storage media 180. In some embodiments, the device 100 may also include one or more auxiliary sensors 190, for example a temperature sensor 192, a sound sensor 194 (e.g., a microphone), an inertial measurement unit (IMU) 196, and/or a proximity sensor 198. Additionally, as described in detail below, the device 100 includes a non-visual imager 120 and an obfuscation-aware compressor 160.

The visual imager 110 may be any hardware device suitably configured to capture light from a scene and output data indicative of the captured image. For example, the visual imager 110 may be a complementary metal-oxide-semiconductor (CMOS) image sensor (i.e., a semiconductor chip that converts photons into electrical signals, which are then processed and output in the form of digital image data).

The non-visual imager 120 may be any hardware device suitably configured to capture signals from the scene captured by the visual imager 110 (e.g., light outside the human-visible spectrum or non-light based waves) that can be used to identify the pixels in the image data output by the visual imager 110 that are occupied by humans. The non-visual imager 120 may be, for example, be a thermal infrared imager, a depth camera (e.g., a time-of-flight (ToF) depth camera, a structured light camera, an interferometry-based depth sensor, etc.), a millimeter-wave (MMW) imager, a near-infrared (NIR) imager, etc.

The visual imager 110 and the non-visual imager 120 are arranged and calibrated such that each pixel captured by the non-visual imager 120 is captured from a portion of the scene that is captured by one or more corresponding pixels of the visual imager 110. In preferred embodiments, the non-visual imager 120 is a low-resolution imager that uses minimal power and computational resources.

The processor 140 and the obfuscation-aware compressor 160 may be realized, separately or by a single hardware component, by any electronic circuit suitably configured to perform the functions described herein. In some embodiments, both the processor 140 and the obfuscation-aware compressor 160 may be realized as a single application-specific integrated circuit (ASIC) having a hardware logic design that is optimized for performing the specific functions described herein. In preferred embodiments, however, the processor 140 is realized as a microcontroller (having a processor core that performs the functions ascribed to the processor 140 by executing software instructions stored in memory) and the obfuscation-aware compressor 160 is realized as a field-programmable gate array (FPGA) having an array of programmable logic blocks and a hierarchy of reconfigurable interconnects configured to perform the functions ascribed to the obfuscation-aware compressor 160.

As described in detail below, the non-visible imager 120 and low-resource, obfuscation-aware compressor 160 enable the device 100 to use dramatically less memory and computation resources while still retaining privacy-preserving capabilities of prior art privacy-preserving cameras (realized using only a visual imager and a commodity system-on-chip). That reduced memory and compute burden paves the way for a smaller, less obtrusive, and easier-to-deploy wearable camera while still preserving privacy.

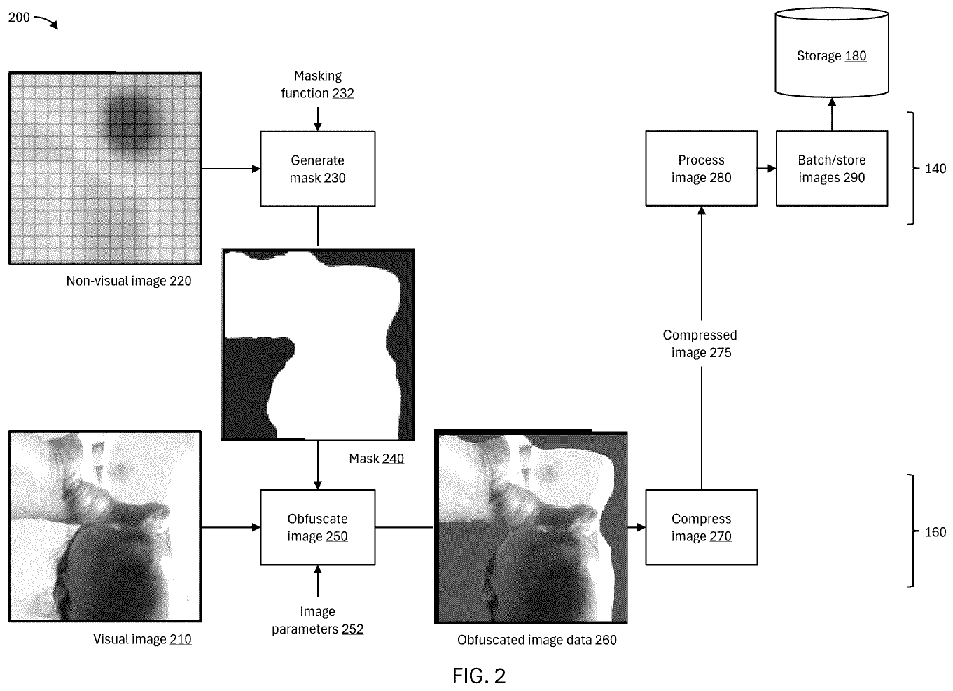

FIG. 2 is a flowchart illustrating a process 200 for obfuscating, compressing, and storing images according to exemplary embodiments. As shown in FIG. 2, some processing steps are performed by the processor 140 while others are performed by the obfuscation-aware compressor 160.

The disclosed device 100 allows for the discarding of specific pixels within a frame through masking. A mask 240 is a low-resolution, binarized image where ‘false’ values denote pixels that should be obfuscated (by either blurring or zeroing out the pixels) and ‘true’ values denote blocks of pixels to store.

As shown in FIG. 2, a visual image 210 is captured by the visual imager 110. Enhancing wearer privacy for body-worn implementations of the device 100 involves identifying which pixels of the visual image 210 are occupied by humans (i.e. the wearer themselves or bystanders) and creating an obfuscation mask 240 from this information. The most straightforward way of identifying humans in a visual image 210 is to operate directly on the video image 210 itself; however, known methods for doing this incur massive memory and computation costs, limiting how far privacy-preserving wearable cameras can be miniaturized. Accordingly, to provide a device 100 that can be body worn and provide a platform for human-centered studies, the device 100 includes a non-visible imager 120 (e.g. infrared or depth) that is inherently sensitive to human wearers, allowing for the generation of human-centered masks 240.

As shown in FIG. 2, a non-visual image 220 captured by the non-visual imager 120 is received by the processor 140, which generates a binarized obfuscation mask 240 in accordance with the non-visual image 220 by executing a mask generation function 232 in step 230.

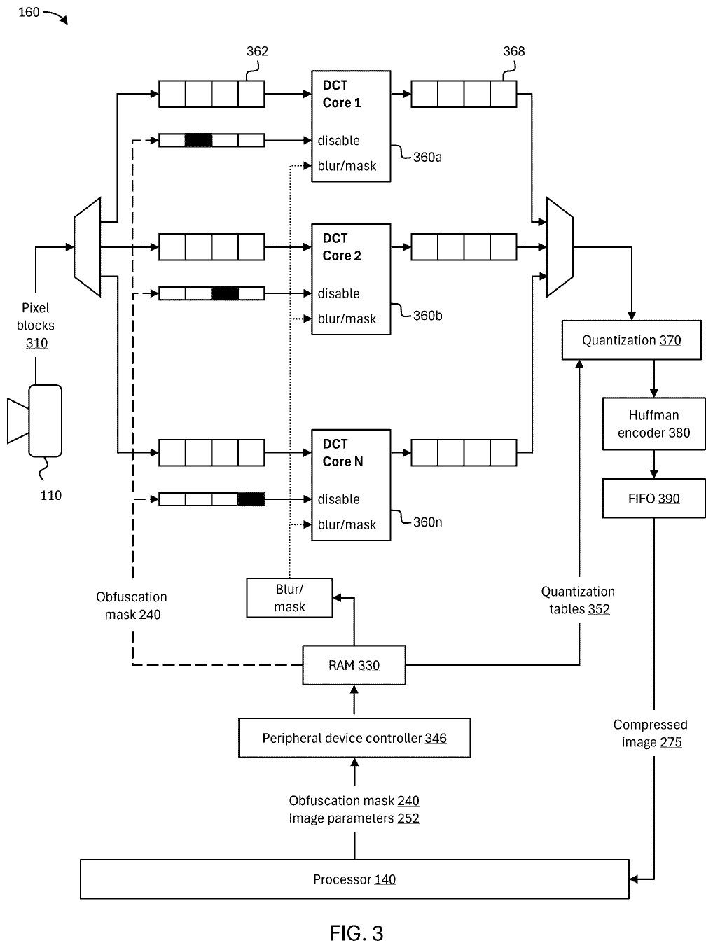

The obfuscation mask 240 generated by the processor 140 is sent to the obfuscation-aware compressor 160, which receives the visual image 210 captured by the visual imager 110 and discards pixels from the visual image 210 to form obfuscated image data 260 in step 250 before compressing the obfuscated image data 260 to form compressed image 275 in step 270. As described in detail below with reference to FIG. 3, for example, the obfuscation-aware compressor 160 may use discrete cosine transformation (DCT) to compress each visual image 210 according to the joint photographic experts group (JPEG) specification. Before coding each block of pixels in the visual image 210, the obfuscation-aware compressor 160 checks the mask to determine if that pixel block is to be obfuscated, in which case DCT coefficients for that pixel block are left at 0, rendering that part of the obfuscated image data 260 as a gray box.

The compressed image 275 is sent to the processor 140, which processes the compressed image 275 in step 280, for example by adding a timestamp and/or data from one or more auxiliary sensors 190, encrypting the compressed image 275, etc. In step 290, the processor 140 batches the compressed images 275 and stores the image batches in the storage 180.

In various implementations, the mask generation function 232 can range from speedy threshold-based setting methods, to region of interest identification, to more intensive machine learning-based approaches such as FastGRNN. Because masks 240 generated from secondary imagers using computationally efficient methods are typically low-resolution, each binary ‘pixel’ in the obfuscation mask 240 may correspond to a block of multiple pixels (e.g., an 8×8 block of pixels) in the visual image data 210.

Various users (e.g., conducting or participating in human-centered studies) may wish for the device 100 to discard different pixels. In a user study evaluating a gesture detection wearable, for example, the device 100 may only need to capture the wearer and may obfuscate the rest of the scene as shown in FIG. 2. In a life-logging setting, on the other hand, blurring/masking people (including the wearer) while cataloging the environment and places visited might be sufficient. Therefore, the mask generation function 232 may be a programmer-defined function defining which pixels to keep and which ones to discard. In those embodiments, the device 100 provides a flexible platform that can be used to implement various definitions of pixel utility (and participants with varying notions of privacy). In embodiments where the processor 140 is realized as a microcontroller, for example, changing the masks 260 involves flashing a new mask generation function 232 to the microcontroller, which is made easy by widely-available open-source programming tools. Accordingly, the device 100 enables a programmable definition of pixel utility (and therefore privacy), bringing programmer-defined masking to compact, long-lifetime wearable cameras.

In addition to the pixel discard described above, the device 100 may use the non-visual image 220 to discard entire frames (e.g., if the non-visual image 220 indicates that a human is not in the scene of a visual image 210). Because the visual images 210 are obfuscated and compressed (and, in some instances, discarded) before being sent to the processor 140, the processor 140 only ever receives, processes, and stores the relevant pixels. In addition to the pixel-and frame-level discard, the device 100 may also provide functionality to programmatically adjust the resolution and/or compression aggressiveness, further reducing the storage and computational resources. In embodiments that include one or more auxiliary sensors 190, the device 100 may be configured to modulate the pixel-level discard process, frame-level discard, resolution, and/or compression aggression in response to sensor data.

On the processor 140, separate threads may be responsible for reading the non-visual images 220 from the non-visual imager 120, extracting obfuscation masks 240 from the non-visual images 240, receiving the compressed images 275 than the obfuscation-aware compressor 160, and processing, batching, and storing the privacy-enhanced images to the storage 180. In embodiments where the processor 140 is implemented as a microcontroller, software (such as FreeRTOS) may be used to manage those multiple threads and to save power when the MCU core is asleep. The MCU's DMA features may also be used to minimize the processing power (for instance, less than 1% of CPU time) that is dedicated to coordinating data movement.

FIG. 3 is a block diagram illustrating a hardware-implemented (e.g., FPGA-implemented) obfuscation-aware compressor 160 according to exemplary embodiments.

The obfuscation-aware compressor 160 forms a selective compression and obfuscation circuit that takes in a mask 260 provided by the processor 140 and outputs a privacy enhanced, obfuscated JPEG image (compressed image 275) back to the processor 140. Accordingly, as described below, the FPGA forms a modified circuit level implementation of the JPEG image compression algorithm.

In the embodiment of FIG. 3, the obfuscation-aware compressor 160 includes random access memory (RAM) 330 (e.g., embedded FPGA SRAM), a peripheral device controller 346, ingestion logic that receives pixel blocks 310 (e.g., 8×8 pixels blocks 310) from the visual imager 110, a number of discrete cosine transform (DCT) cores 360a, 360b, etc. (individually and collectively referred to as DCT core(s) 360), a quantization module 370, a Huffman encoder 380, output logic, and a first-in-first-out (FIFO) buffer 390.

The quantization module 370 quantizes high frequency components of the images 210 in accordance with pre-set quantization tables 352. Those components are less obvious to the human eye, producing long runs of easy to encode low entropy data. The quantized stream is provided to the Huffman encoder 380. A fixed codebook used by the Huffman encoder prioritizes the most common symbols, giving them shorter codewords. Because of the quantization step, some symbols are much more likely to appear than others, making Huffman encoding highly effective.

The obfuscation-aware compressor 160 receives the obfuscation mask 240 and image parameters 252 from the processor 140, which are stored in the RAM 330. The image parameters 252 may include data indicative of a framerate, a resolution, and/or a compression quality (e.g., updates to the quantization tables 352) of the compressed image and/or an instruction to blur or mask the pixels in accordance with the obfuscation mask 240. The processor 140 may store default image parameters 252, which may be specified either prior to deployment or by the user/programmer. The processor 140 may provide functionality for the user to modify one or more of the image parameters 252. The processor 140 may be configured to provide the image parameters 252 to the obfuscation-aware compressor 160 at startup. Once the obfuscation-aware compressor 160 stores the image parameters 252 received from the processor 140, the obfuscation-aware compressor 160 may be configured to obfuscate and compress each visual image 210 in accordance with the received obfuscation masks 240 unless and until the processor 140 provides modified image parameters 252.

The visual image 210 is in ingested pixel blocks 310 (called minimum coded units), which are fed to the DCT cores 360 running in parallel. Each DCT core 360 is responsible for its own stream of minimum coded units. Once the DCT operation is complete, the results from all of the parallel DCT cores 360 are interleaved and provided to the quantization module 370.

Each DCT core 360 may be realized as a micro-coded multiplier and adder with a FIFO 362 at its input and a FIFO 368 at its output for buffering. Each DCT core performs a discrete cosine transform that converts the pixel data from the spatial domain (pixel values representing location and color) to the frequency domain (coefficients representing spatial frequencies). Specifically, for each 8×8 pixel block 310, a DCT core 360 may output a 64-element matrix (or 8×8 block) of DCT coefficients. Those DCT coefficients include a DC coefficient representing the average color or brightness of the entire pixel block 310 and AC coefficients representing the spatial frequency components within the block (i.e., lower frequencies representing more gradual changes in color/brightness and higher frequencies representing finer details and rapid changes in color/brightness like edges or textures).

In order to selective obfuscate certain pixel blocks 310 in accordance with the obfuscation mask 240, each DCT core 360 is gated. The pixel block 310 under consideration is blurred or masked if the corresponding pixel block in the obfuscation mask 360 is 1. Because every DCT coefficient added decreases blur, a pixel block 310 can be blurred out by throwing away high frequency coefficients when doing JPEG compression (and, as a result, aggressively reducing the quality for that pixel block). Accordingly, in the embodiment of FIG. 3, the pixel blocks 310 are obfuscated in accordance with the obfuscation mask 240 by compressing that pixel block with the highest amount of blur (i.e., keeping only the DC component of the DCT coefficients).

By obfuscating and compressing the visual image 210, the obfuscation-aware compressor 160 eliminates the need for the processor 140 to process or even receive any unnecessary pixel data (i.e., uncompressed pixel data or pixels that will ultimately be obfuscated). Additionally, the obfuscation-aware compressor 160 of FIG. 3 has reduced memory requirements when compared to commodity hardware-JPEG-enabled MCUs for a number of reasons. As an initial matter, performing the central operation of JPEG compression (the DCT) by many small DCT cores 360 in parallel reduces hardware size. Additionally, by obfuscating the image 210 in a streaming fashion, the obfuscation-aware compressor 160 can perform obfuscation and compression without ever storing more than 16 lines of the visual image 210 at once. The requirement to store only 16 lines of the visual image 210 enables the obfuscation-aware compressor 160 to be realized as a small FPGA with very little SRAM. Meanwhile, because the memory usage the disclosed obfuscation-aware compressor 160 scales with 0 (VN) in the number of pixels, larger visual imagers 110 can be used without incurring massive SRAM costs.

The obfuscation-aware compressor 160 may also be implemented using reduced division precision. Quantization (the critical step in JPEG where data loss actually takes place) relies on notoriously expensive division hardware. Accordingly, instead of using full-precision integer division (which may occupy half of a FPGA), the disclosed obfuscation-aware compressor 160 may allow for division by numbers of the form k2^{q} for k∈[0, 2^{l}]. In those embodiments, the obfuscation-aware compressor 160 may be realized using a 16×8 bit divider rather than an l-bit divider and a q-bit barrel shifter.

Because of its low memory footprint, the obfuscation-aware compressor 160 upends the notion that transform coding is not possible in the lowest-powered systems and, even putting aside the mask generation and obfuscation process performed by the disclosed device 100, provides its own specific technical benefits.

As briefly mentioned above, both the processor 140 and the obfuscation-aware compressor 160 may be realized as a single application-specific integrated circuit (ASIC) having a hardware logic design that is optimized for performing the specific functions described above. Fabricating an ASIC, however, requires large amounts of money, manpower, and extensive know-how and connections. Meanwhile, performing prior art obfuscation processes using off-the-shelf components in a bulky and power-hungry circuit. Accordingly, by using a secondary non-visible imager 120 to generate privacy masks 240, the disclosed device 100 avoids the need for DRAM and high-performance processors that would be needed to generate privacy masks directly from the visual images 110. Furthermore, by obfuscating and compressing the visual images 210, the disclosed obfuscation-aware compressor 160 eliminates the need for the processor 140 to include the hardware and SRAM buffer space needed to perform JPEG compression, enabling the disclosed processor 140 to be realized using an extremely tiny, low-performance MCU. Accordingly, those features enable disclosed device 100 to be realized as a smaller and lower-power device that still preserves privacy without turning to prohibitively difficult methods. In fact, even if the non-visible imager 110 consumes more power than a high-resolution CMOS sensor, the power needed to generate an obfuscation mask 240 from the non-visible imager 110 is less than the power needed to generate obfuscation mask 240 mask from a high-resolution CMOS sensor.

In some embodiments, the processor 140 may also be realized as an FPGA (which may improve system integration). In preferred embodiments, however, the processor 140 is realized as a microcontroller for a number of reasons. First, performing the functions ascribed above to the processor 140 would require a larger, more expensive FPGA and would be less efficient for the tasks in question. Furthermore, flexibility and researcher usability are important for the disclosed device 100. Changing the mask generation function 232, for example, would be more difficult if the disclosed processor 140 were implemented in hardware. Meanwhile, implementing a soft-core on the FPGA would likely be too inefficient for the reasons mentioned above. Accordingly, by splitting the responsibilities described above between an FPGA and a microcontroller, the disclosed device 100 can be realized using the smallest-in-class chips for both the processor 140 and the obfuscation-aware compressor 160.

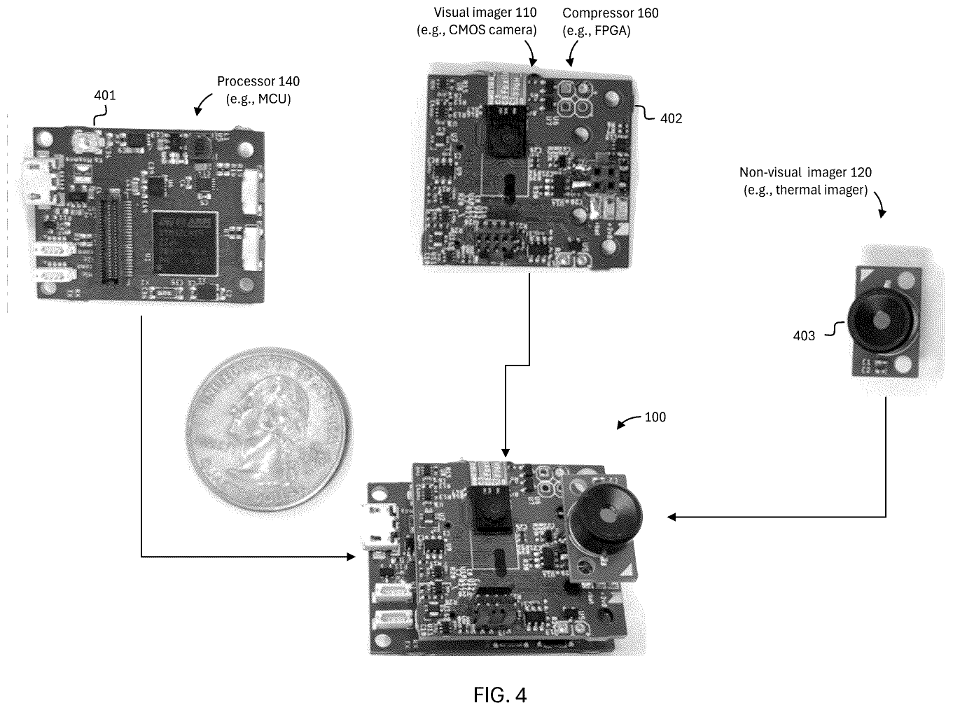

FIG. 4 is an image of an exemplary modular implementation of the disclosed device 100. In the embodiment of FIG. 4, the device 100 is realized as a motherboard 401, an FPGA and camera board 402, and a thermal imager 403.

The motherboard 401 is the central controller, which hosts an ST Microelectronics STM32LAS9ZI microcontroller (the processor 140 in this embodiment), which is an Arm Cortex-M4 running at 120 MHZ, with 2 MBytes of Flash memory and 640 KBytes of SRAM onboard. The motherboard 401 includes an SD card, an IMU 196, and compact connectors for additional i2c sensors 190 (e.g., a temperature sensor 192, and/or a proximity sensor 198) as needed. The motherboard 401 connects to the FPGA and camera board 402 via a stackable connector that contains an i2c control bus for the FPGA (the obfuscation-aware compressor 160 in this embodiment) and camera, a separate i2c bus for the non-visible imager 120, and an 8-bit wide parallel data bus for receiving compressed video from the FPGA. The i2c control connection is sufficient bandwidth for control signals and streaming obfuscation masks 240, which require 10 s of kb/s (only a few percent of the i2c bus's bandwidth). The motherboard 401 also includes battery charge and management circuits, user buttons and programming ports.

The FPGA and camera board 402 contains a Lattice iCE40 UP5K Field Programmable Gate Array (FPGA) and a Himax HM01B0 (the visual imager 110 in this embodiment). The iCE40 is an affordable, ultra low power FPGA that's suitable for compact, low-power applications. The Himax HM01B0 image sensor is able to capture 30 QVGA resolution (320×240 pixels) frames per second while taking only consuming 1 mW of power.

A mid-resolution thermal imager 403 is a good way to identify humans in a scene in a way that is robust to light/dark cycles and other environmental effects of images and depth sensors. This non-visual imager 120 is used to create obfuscation masks 240 to hide private features of the visual images 110. The thermal imager 403 may be realized as a MLX90640, which has a 110°×75° field of view, a resolution of 32×24 pixels, and a temperature range of −40° C. to 85° C.

While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. A wearable image capture and compression device, comprising:
a visible imager that captures image data within a field of view, the image data forming a series of image frames, each image frame including a plurality of pixel blocks;
a non-visible imager that captures signals outside the human-visible spectrum from objects within the field of view;
a processor that generates an obfuscation mask, based on the signals captured by the non-visible imager, marking each pixel block in the image frame for either obfuscating or passing the pixel block; and
an obfuscation-aware compressor that obfuscates and compresses each image frame by:
buffering a subset of the pixel blocks included in image frame;
obfuscating the pixel blocks marked for obfuscating by the obfuscation mask; and
compressing the pixel blocks marked for passing by the obfuscation mask.

2. The device of claim 1, wherein:
each image frame comprises M pixel blocks; and
the hardware image compressor sequentially buffers, obfuscates, and compresses N pixel blocks, where M>N.

3. The device of claim 1, wherein:
the obfuscation-aware compressor compresses each pixel block by performing a discrete cosine transform (DCT) to calculate a plurality of DCT coefficients; and
the obfuscation-aware compressor obfuscates the pixel blocks marked for obfuscating by the obfuscation mask by setting some or all of the DCT coefficients to 0.

4. The device of claim 3, wherein the obfuscation-aware compressor further compresses each pixel block by performing quantization and Huffman encoding.

5. The device of claim 4, wherein the obfuscation-aware compressor performs quantization using a 16×8-bit divider that allows for division by numbers of the form k29 for k∈[0, 2^{l}].

6. The device of claim 1, wherein the obfuscation-aware compressor is a field-programmable gate array (FPGA).

7. The device of claim 1, wherein the processor generates the obfuscation mask in accordance with the signals captured by the non-visible imager by executing a mask generation function.

8. The device of claim 1, wherein the processor is a microcontroller.

9. The device of claim 1, wherein the processor provides functionality for users to specify or modify the mask generation function.

10. The device of claim 1, wherein the non-visible imager is an infrared thermal imager or a time-of-flight depth camera.

11. A method of capturing, obfuscating, and compressing images, the method comprising:
capturing image data within a field of view, by a visible imager, the image data forming a series of image frames, each image frame including a plurality of pixel blocks;
capturing signals outside the human-visible spectrum, by a non-visible imager, from objects within the field of view;
generating an obfuscation mask, by a processor, in accordance with the signals captured by the non-visible imager, the obfuscation mask marking each pixel block in the image frame for either obfuscating or passing the pixel block; and
obfuscating and compressing each image frame, by an obfuscation-aware compressor, by:
buffering a subset of the pixel blocks included in image frame;
obfuscating the pixel blocks marked for obfuscating by the obfuscation mask; and
compressing the pixel blocks marked for passing by the obfuscation mask.

12. The method of claim 11, wherein obfuscating and compressing each image frame comprises obfuscating and compressing a plurality of pixel blocks in parallel.

13. The method of claim 11, wherein:
compressing each pixel block comprises performing a discrete cosine transform (DCT) to calculate a plurality of DCT coefficients; and
obfuscating the pixel blocks marked by the obfuscation mask comprises setting some or all of the DCT coefficients to 0.

14. The method of claim 13, wherein compressing each pixel block further comprises performing quantization and Huffman encoding.

15. The method of claim 14, wherein the quantization is performed using a 16×8-bit divider that allows for division by numbers of the form k2^{q} for k∈[0, 2^{l}].

16. The method of claim 11, wherein the obfuscation-aware compressor is a field-programmable gate array (FPGA).

17. The method of claim 11, wherein generating the obfuscation mask in accordance with the signals captured by the non-visible imager comprises executing a mask generation function.

18. The method of claim 11, wherein the processor is a microcontroller.

19. The method of claim 11, further comprising: providing functionality for a user to specify or modify the mask generation function.

20. The method of claim 11, wherein the non-visible imager is an infrared thermal imager or a time-of-flight depth camera.
